(19) United States
(12) Patent Application Publication
(10) Pub. No.: US 2025/0368175 A1
(43) Pub. Date: Dec. 4, 2025

(54) SINGLE ELECTRIC BRAKE BOOSTER MODULE WITH REDUNDANT ELECTRONICS

(71) Applicant: Ford Global Technologies, LLC, Dearborn, MI (US)

(72) Inventors: Ethan Kaese, Keego Harbor, MI (US); Julie Verdun, Franklin, MI (US); Harold John Felch, Novi, MI (US); Thomas Svensson, Leichlingen (DE); Rosario Rivas Gaytan, West Bloomfield, MI (US)

(21) Appl. No.: 18/733,219

(22) Filed: Jun. 4, 2024

(51) Int. Cl. B60T 13/66; B60T 8/171; B60T 13/58; B60T 13/74; B60T 17/22

(52) U.S. Cl. CPC B60T 13/662; B60T 8/171; B60T 13/58; B60T 13/746; B60T 17/22; B60T 2220/04; B60T 2270/402; B60T 2270/404; B60T 2270/406; B60T 2270/413; B60T 2270/414

(57) ABSTRACT

A vehicle control system of a vehicle may include an electronic brake booster module to adjust front brakes of a braking system of the vehicle, a pedal travel sensor and a pedal angle sensor operably coupled to a brake pedal of the vehicle, a vehicle control module that may be configured to monitor the vehicle control system, and a first power supply and a second power supply operably coupled to the electronic brake booster module. The electronic brake booster module may further include a first circuit board to control brake actuation and a second circuit board to control brake modulation, and the vehicle control module or the electronic brake booster module may determine a fallback condition based on a fault state determined based on the pedal actuation, the pedal angle, and operational status of one or more of the first power supply and the second power supply.

### TECHNICAL FIELD

Example embodiments generally relate to vehicle braking systems and, more particularly, relate to a system that provides redundant power for brake assemblies of different types.

### BACKGROUND

Brake boost systems are commonly used in automotive settings in order to increase the actuation force from a driver's foot on a brake pedal. For autonomous vehicles, accurate, responsive, and automatic brake boost systems are important to efficient automated driving. As such, redundancy of components within the brake boost system ensures system functionality. However, typical redundancy within brake boost systems includes inefficiency in operation, positioning, and application of the system.

Thus, it may be desirable to develop an architecture that provides redundant power supply and signaling capabilities with efficient transfers and fallbacks within the entire braking system.

### BRIEF SUMMARY OF SOME EXAMPLES

In accordance with an example embodiment, a vehicle control system of a vehicle may be provided. The vehicle control system may include an electronic brake booster module to adjust front brakes of a braking system of the vehicle, a pedal travel sensor operably coupled to a brake pedal of the vehicle to measure pedal actuation, a pedal angle sensor operably coupled to the brake pedal of the vehicle to measure pedal angle, a vehicle control module that may be configured to monitor the vehicle control system, a first power supply operably coupled to the electronic brake booster module, and a second power supply operable coupled to the electronic brake booster module. The electronic brake booster module may further include a first circuit board to control brake actuation and a second circuit board to control brake modulation, and the vehicle control module or the electronic brake booster module may determine a fallback condition based on a fault state determined based on the pedal actuation, the pedal angle, and operational status of one or more of the first power supply and the second power supply.

In another example embodiment, an electronic brake booster module for a vehicle control system of a vehicle may be provided. The electronic brake booster module may include a first circuit board to control brake actuation, and a second circuit board to control brake modulation. A first power supply and a second power supply may be operably coupled to the electronic brake booster module, and the electronic brake booster module may be configured to adjust front brakes of a braking system of the vehicle. The electronic brake booster may be further operably coupled to a pedal travel sensor operably coupled to a brake pedal of the vehicle to measure pedal actuation and a pedal angle sensor operably coupled to the pedal of the vehicle to measure pedal angle. The electronic brake booster module or a vehicle control module of the vehicle control system may determine a fallback condition based on a fault state determined based on the pedal actuation, the brake pedal angle, and operational status of one or more of the first power supply and the second power supply.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 illustrates a block diagram of some components of the electronic brake boost (EBB) module of FIG. 1 in accordance with an example embodiment; and

FIG. 3 illustrates a block diagram of physical boundary diagram featuring an EBB module associated with braking control in accordance with an example embodiment;

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Normally, the redundancy for a pure hydraulic brake system is provided through mechanical hydraulic push through of a brake pedal on a hydraulic cylinder supplying braking pressure to all four wheel ends. In some situations and vehicle architectures, the rear brake circuits are isolated from the front brake circuits during mechanical hydraulic push through with the rear electric park brakes employed to deliver additional braking torque. Front electronic brake boost (EBB) hydraulic, rear axle electromechanical brake (EMB) architectures in passenger vehicles require a redundant power supply and a supporting control structure. However, as noted above, doing so in a context in which different brake systems are employed may be difficult to achieve, and signaling in backup modes of operation may be difficult to achieve as well. Example embodiments aim to provide separate power supplies transferring power to a single EBB module with multiple circuit boards to introduce redundancy for the front hydraulic brakes that may work well for autonomous driving applications. The integration of the single EBB module along with the other components of the vehicle control system and the specific vehicle architecture may enhance the capabilities for autonomous driving applications.

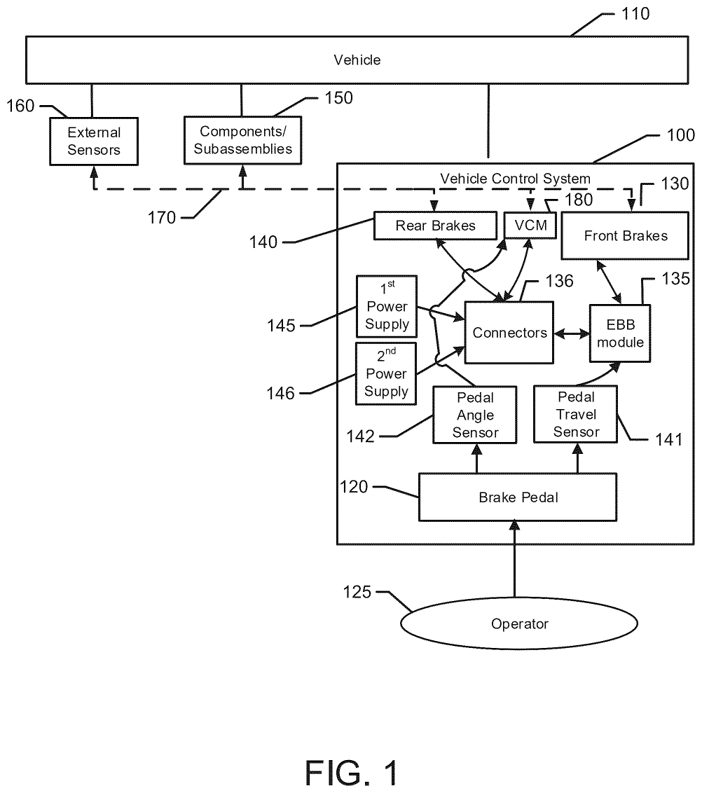

FIG. 1 illustrates a block diagram of a vehicle control system 100 of an example embodiment. The components of the vehicle control system 100 may be incorporated into a vehicle 110 (e.g., via being operably coupled to a chassis of the vehicle 110, various components of the vehicle 110 and/or electronic control systems of the vehicle 110). Of note, although the components of FIG. 1 may be operably coupled to the vehicle 110, it should be appreciated that such connection may be either direct or indirect. Moreover, some of the components of the vehicle control system 100 may be connected to the vehicle 110 via intermediate connections to other components either of the chassis or of other electronic and/or mechanical systems or components. In some cases, the chassis may include or be defined by a frame, and the frame may additionally be formed of one or more casted subframes.

The control system 100 may include one or more input devices in the form of one or more control pedals. In some embodiments, the control pedals may include a brake pedal 120 that is generally foot operated by an operator 125 to initiate braking forces, or braking torque application at the wheels of the vehicle 110. The brake pedal 120 may be operably coupled to front brakes 130 via mechanical coupling under control of an EBB module 135. In an example embodiment, the front brakes 130 may be hydraulic brakes, and the brake pedal 120 may be hydraulically coupled to the front brakes 130. The brake pedal 120 may also be operably coupled to rear brakes 140. In some cases, the rear brakes 140 may be EMBs. The front brakes 130 and the rear brakes 140 may be operably coupled to a pedal travel sensor 141 to receive position information indicative of the brake pedal 120 and a pedal angle sensor 142 to receive angle measurements of the brake pedal 120. The pedal travel sensor 141 may provide data indicative of the precise actuation of the brake pedal 120, and the pedal angle sensor 142 may provide data indicative of the precise angle of the brake pedal 120. In an example embodiment, the data provided by the pedal travel sensor 141 and the pedal angle sensor 142 may be provided as inputs to the EBB module 135 and a vehicle control module (VCM) 180 respectively. In some cases, the data associated with the pedal travel sensor 141 and the pedal angle sensor 142 may be provided as inputs to other vehicle control modules directly or to other vehicle control modules through the EBB module 135 and various connectors 136. In an example embodiment, the pedal travel sensor 141 may be internal to the EBB module 135.

Notably, the control pedals could alternatively be hand operated or any other operable member via which the operator 125 may provide an input indicative of an intent of the operator 125 relative to controlling net torque for application to the wheels of the vehicle 110. In some cases, the control system 100 may be configured to perform other tasks related or not related to propulsive and braking control or performance management.

In an example embodiment, the control system 100 may receive information that is used to determine vehicle status from various components or subassemblies 150 of the vehicle 110. Additionally or alternatively, various sensors that may be operably coupled to the components or subassemblies 150 may be included and may provide input to the control system 100 that is used in determining vehicle status. Such sensors may be part of a sensor network 160 and sensors of the sensor network 160 may be operably coupled to the control system 100 (and/or the components or subassemblies 150) via one or more instances of a vehicle communication bus (e.g., a controller area network (CAN) bus) 170.

In some cases, the vehicle control system may include the VCM 180 outside of the EBB module 135. The VCM 180 may communicate with the sensor network 160, the components or subassemblies 150, as well as various vehicle control system 100 components operably coupled to the various connectors 136. In an example embodiment, the VCM 180 may operate as a fallback if the EBB module 135 experiences a fault. In some cases, the fallback may be the VCM 180 fully or partially controlling the front brakes 130 of the vehicle 110.

The components or subassemblies 150 may include, for example, a braking system, a propulsion system and/or a wheel assembly of the vehicle 110. The braking system may be configured to provide braking inputs to braking components of the vehicle 110, and includes the components discussed above. One or more corresponding sensors of the sensor network 160 that may be operably coupled to the brake system and/or the wheel assembly may provide information relating to brake torque, brake torque rate, vehicle velocity (including rate of change of velocity), front/rear wheel speeds, vehicle pitch, etc. Inputs from the sensors of the sensor network 160 may be provided to the control system 100 to enable the control system 100 to provide various primary and secondary (or backup) control functions related to the components or subassemblies 150. Accordingly, for example, the control system 100 may be able to receive numerous different parameters, indications and other information that may be related to or indicative of different situations or conditions associated with vehicle status. The control system 100 may also receive information indicative of the intent of the operator 125 relative to control of various aspects of operation of the vehicle 110 and then be configured to use the information received to provide instructions to control responses to the situations or conditions determined.

In some cases, the EBB module 135 may be powered by a first power supply 145 and a second power supply 146. The first power supply 145 and the second power supply 146 may be operably coupled to the EBB module 135 directly or through the various connectors 136. The first power supply 145 and the second power supply 146 may be a variety of different power sources, such as but not limited to various types of batteries.

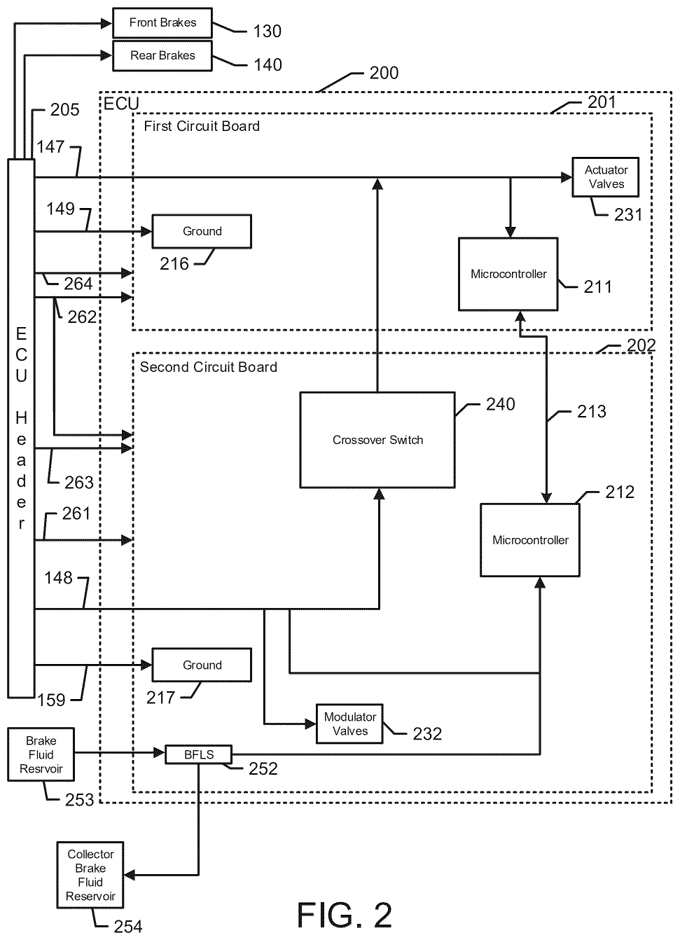

FIG. 2 illustrates a block diagram of various components of the EBB module 135, which may be considered either a specific example of the vehicle control system 100 of FIG. 1, or a portion thereof that is associated with a vehicle braking system.

In some cases, the EBB module 135 may include an electronic control unit ECU 200. The ECU 200 of the EBB module 135 may control the aspects of the braking system via receiving input data from a variety of sensors (including the pedal travel sensor 141 and the pedal angle sensor 142) and processing the input data to determine an adjustment, actuation, or modification of specific brakes of the braking system. For example, the ECU 200 may process the precise actuation data from the pedal travel sensor 141 and the pedal angle data from the pedal angle sensor 142 to determine the amount of brake boosting to provide to the front hydraulic brakes.

In an example embodiment, the ECU 200 may perform the processing with one or more microcontrollers. The one or more microcontrollers may include processing circuitry that includes a processor and memory. The processing circuitry may be configured to provide electronic control of the inputs to one or more functional units of the vehicle control system 100 and to process data received at or generated by the one or more functional units of the vehicle control system. Thus, the processing circuitry may be configured to perform data processing, control function execution and/or other processing and management services according to an example embodiment. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules (including the VCM 180) may include similar processing circuitry.

In some cases, the ECU 200 may include one or more circuit boards to operably couple and/or wire various necessary electronic components together to enable the EBB module 135 functionality. In an example embodiment, the ECU 200 may include multiple circuit boards that each have a different planned functionality. For example, in some cases, the ECU 200 may have a first circuit board 201 to control brake actuation and a second circuit board 202 to control brake modulation. In an example embodiment, the first circuit board 201 may determine if brake boosting is needed. In some cases, the second circuit board 202 may determine the degree of brake boosting needed to achieve a target torque of the front brakes 130. The first circuit board 201 and the second circuit board 202 may include their own, separate microcontrollers. The first circuit board 201 may include an actuation microcontroller 211, the second circuit board 202 may include a modulation microcontroller 212.

In an example embodiment, the first circuit board 201 and the second circuit board 202 may be powered by separate power supplies. For example, the first circuit board 201 may be powered by the first power supply 145, and the second circuit board 202 may be powered by the second power supply 146. In some cases, the first power supply 145 may provide power to the first circuit board 201 via an ECU header 205 and a first power line 147, and the second power supply 146 may provide power to the second circuit board 202 via the ECU header 205 and a second power line 148. In an example embodiment, the power supplies may directly operably couple to the ECU 200 without utilizing the ECU header 205. In some cases, the first power supply 145 and the second power supply 146 may provide power to other components, sensors, or devices within the vehicle control system 100 besides the ECU 200. The ECU header 205, in some cases, may be directly part of the EBB module 135 or may be part of the various connectors 136 seen in FIG. 1.

In some cases, the first circuit board 201 and the second circuit board 202 may further be operably coupled to respective ground lines via respective ground terminals. For example, a first respective ground line 149 may ground the first circuit board 201 via a first ground terminal 216, and a second respective ground line 159 may ground the second circuit board 202 via a second ground terminal 217. The respective ground lines and the respective ground terminals may help ground the power transfer from the power supplies to the ECU 200 in case of a short circuit.

In an example embodiment, the ECU 200 may include actuator valves 231, which may be valves that control the opening and closing of hydraulic fluid flow to the front brakes 130. Modulator valves 232 may also be included and control the specific rate of hydraulic fluid flow to the front brakes 130 based on determinations by the modulation microcontroller 212. In some cases, a private communication link 213 may connect the actuation microcontroller 211 and the modulation microcontroller 212.

In some cases, the ECU 200 may include a crossover switch 240. The crossover switch 240 may allow the transfer of power from either one of the first circuit board 201 or the second circuit board 202 to the other circuit board in case of power supply faults. The crossover switch 240 may be operably coupled and in communication with the actuation microcontroller 211 and the modulation microcontroller 212. In an example embodiment, the actuation microcontroller 211 may determine the operational status of the first power supply 145 and communicate the determined operational status to the crossover switch 240. Similarly, the modulation microcontroller 212 may support the operational status of the second power supply 146 and communicate the determined operational status to the crossover switch 240.

In some cases, the operational status of the first power supply 145 or the second power supply 146 may indicate the degree of functionality of the respective power supply. For example, the operational status of the power supply may be determined to be fully functional or experiencing a power supply fault. The determination of the operational status of the power supply may be performed by the one or more microcontrollers.

In an example embodiment, the crossover switch 240 may receive indications that the operational status of both power supplies are fully functional, and thus not transfer power between either circuit board of the ECU 200. In some cases, responsive to a determination that the operational status of one of the first power supply 145 or the second power supply 146 is experiencing a power supply fault, a fault state for the ECU 200 or the EBB module 135 may be determined to be a single power supply fault. Responsive to determining the ECU 200 or the EBB module 135 is experiencing a fault state, a fallback condition may be determined and executed by EBB module 135. In some cases, the fallback condition may be determined by the one or more microcontrollers, but the fallback condition determination is not limited to the microcontrollers and may be determined by other component of the EBB module 135 or vehicle control system 100.

In an example embodiment, responsive to the fault state being determined to be the single power supply fault, the crossover switch 240 may transfer power to one or more of the first circuit board 201 or the second circuit board 202 experiencing the single power supply fault from the remaining one or more of the first circuit board 201 or the second circuit board 202 not experiencing the single power supply fault. In an example embodiment, responsive to the first circuit board 201 experiencing a single power supply fault, the crossover switch 240 may transfer power or voltage from the second circuit board 202 to the first circuit board 201. The power may be transferred directly to the actuation microcontroller 211 to ensure functionality. In some cases, the alternative may occur where responsive to the second circuit board 202 experiencing a single power supply fault, the crossover switch 240 may transfer power or voltage from the first circuit board 201 to the second circuit board 202. The power may be transferred directly to the modulation microcontroller 212 to ensure functionality.

In an example embodiment, the first circuit board 201 and the second circuit board 202 may communicate with one another via a private communication link 213 between the actuation microcontroller 211 and the modulation microcontroller 212. In some cases, the private communication link 213 may be an internal connection between the actuation microcontroller 211 and the modulation microcontroller 212, such as a controller area network (CAN) connection. In an example embodiment, the communication between the private communication link may be a wireless connection between the actuation microcontroller 211 and the modulation microcontroller 212; however, the private communication link is not limited to a CAN or wireless connection and may be any number of types of private communication links/communication protocols that ensure reliable communication connection.

In some cases, the private communication link 213 may assist in determining crossover switch 240 function. For example, if communication is attempted by the actuation microcontroller 211 to the modulation microcontroller 212 and there is a lack of a response from the modulation microcontroller 212, the actuation microcontroller 211 may determine the second circuit board 202 is experiencing a single power supply fault and communicate with the crossover switch 240 to transfer power to the second circuit board 202. In an example embodiment, over the private communication link, the modulation microcontroller 212 may communicate a loss of function of certain second circuit board 202 components and request additional power. As a result, the actuation microcontroller 211 may determine the second circuit board 202 is experiencing a single power supply fault and communicate with the crossover switch 240 to transfer power to second circuit board 202. Additionally, in some cases, the alternative may be true between the modulation microcontroller 212 and the actuation microcontroller 211.

In an example embodiment, responsive to a determination that the operational status of both the first power supply 145 and the second power supply 146 are experiencing a power supply fault, a fault state for the ECU 200 or the EBB module 135 may be determined to be a double power supply fault. A double power supply fault may be determined via the complete loss of communication with components of both the first circuit board 201 and the second circuit board 202. In an example embodiment, the private communication link 213 may determine the double power supply fault via loss of function of specific components.

In some cases, responsive to determining the fault state to be the double power supply fault, the VCM 180 may be configured to execute the fallback condition to have the front brakes operate according to a hydraulic fallback and the rear brakes operate according to an electro-mechanical assist fallback. In an example embodiment, the hydraulic brake fallback may revert the front brakes to purely mechanical brake actuation and modulation via the brake pedal 120. For example, the operator 125 pressing the brake pedal 120 may provide hydraulic fluid into the brake calipers of the front brakes 130. In an example embodiment, the rear brakes 140 may be electro-mechanical brakes (EMBs) that include separate power supplies from the first power supply 145 and the second power supply 146. In some cases, the rear brakes 140 and the VCM 180 may be operably coupled to separate brake pedal sensors than the EBB module 135. In an example embodiment, the electro-mechanical fallback for the rear brakes may provide varying degree of electro-mechanical braking based proportionally on the brake pedal angle, either utilizing data from the separate brake pedal sensors, the pedal travel sensor 141, or the pedal angle sensor 142. In this regard, the fallback condition responsive to determining the fault state to be the double power supply fault may not rely upon the EBB module 135.

In an example embodiment, both the first circuit board 201 and the second circuit board 202 may be operably coupled to a variety of other sensors, components, systems within the EBB module 135 and overall vehicle control system 100. In an example embodiment, the second circuit board 202 may include a brake fluid level sensor (BFLS) 252. The BFLS 252 may be operably coupled to the modulation microcontroller 212, as well as a brake fluid reservoir 253 and a collector brake fluid reservoir 254.

In some cases, the first circuit board 201 and the second circuit board 202 may include multiple communication links with the ECU header 205. For example, both the first circuit board 201 and the second circuit board 202 may have a shared private CAN connection 262. In some cases, both the first circuit board 201 and the second circuit board 202 may have public CAN connections. The first circuit board 201 may have public CAN connection 264 while the second circuit board 202 may have public CAN connection 261. In some cases, the second circuit board 202 may have an individual private CAN connection 263 as well. The communication links are not limited to CAN communications or wireless connections and may be any number of types of communication links/communication protocols that ensure reliable communication connection.

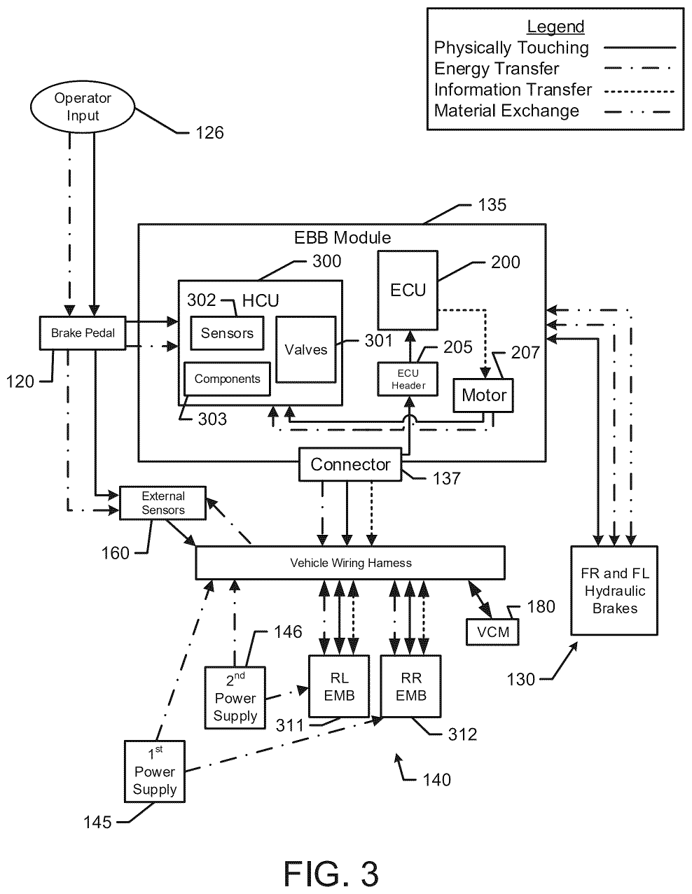

FIG. 3 illustrates a physical boundary diagram featuring the EBB module 135 within a portion of the vehicle control system 100 and the vehicle 110 itself. The physical boundary diagram displays the operable coupling of various components of the vehicle control system 100 in accordance with an example embodiment. Four different types of operable coupling are highlighted in the figure, including physically touching (solid line), energy transfer (dashed and single dotted line), information transfer (dashed line), and material exchange (dashed and double dotted line). In some cases, material exchange may be hydraulic fluid moving to the front brakes 130 and energy transfer may be from physical inputs like operator inputs 126 or a combination of electrical and physical inputs like from a motor 207.

In an example embodiment, the ECU 200 may be operably coupled to a hydraulic control unit (HCU) 300 via the motor 207. In some cases, the HCU 300 may include various valves 301 (e.g. actuator valves 231 and modulator valves 232), sensors 302 (e.g. pedal travel sensor 141 and the pedal angle sensor 142), and components 303 from the EBB module 135. Additionally, the various connectors 136 may include an EBB module connector 137 and a vehicle wiring harness 138. In an example embodiment, the EBB module connector 137 may operably couple the ECU header 205 and the vehicle wiring harness 138. The vehicle wiring harness 138 may operably couple remaining components and systems of the vehicle control system 100 (e.g. VCM 180, rear brakes 140 (i.e. a rear left EMB 311 and a rear right EMB 312), first power supply 145, second power supply 146, external sensor network 160, etc.) to the EBB module 135. In an example embodiment, the rear left EMB 311 and the rear right EMB 312 may be directly operably coupled to either one of the first power supply 145 and the second power supply 146.

In some cases, the multiple communication links (i.e. CAN connections 261, 262, 263, 264, etc.) within the EBB module 135 of vehicle control system 100 may include choke protection. The choke protection may be anywhere along the specific communication link/connection and help ensure reliable communication.

In an example embodiment, the EBB module 135 may be contained within a single enclosed box for convenience in assembly via the reduction of individual components. In an example embodiment, the first power supply 145 and the second power supply 146 may be ASIL B rated. ASIL B rating is consensus rating aimed to set a baseline for power supply to important automotive sensors. Given the ASIL B rating, in some cases, the vehicle 110 may include L3+ autonomous driving capability. L3+ autonomous driving generally may indicate the vehicle 110 can manage most aspects of driving, including monitoring the environment, without human intervention. In some cases, the L3+ autonomous driving mode may be enabled on a subscription basis.

A vehicle control system of a vehicle may therefore be provided. The vehicle control system may include an electronic brake booster module to adjust front brakes of a braking system of the vehicle, a pedal travel sensor operably coupled to a brake pedal of the vehicle to measure pedal actuation, a pedal angle sensor operably coupled to the brake pedal of the vehicle to measure pedal angle, a vehicle control module that may be configured to monitor the vehicle control system, a first power supply operably coupled to the electronic brake booster module, and a second power supply operably coupled to the electronic brake booster module. The electronic brake booster module may further include a first circuit board to control brake actuation and a second circuit board to control brake modulation, and the vehicle control module or the electronic brake booster module may determine a fallback condition based on a fault state determined based on the pedal actuation, the pedal angle, and operational status of one or more of the first power supply and the second power supply.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the first power supply may be operably coupled to the first circuit board, and the second power supply may be operably coupled to the second circuit board. In an example embodiment, the electronic brake booster module may further include a crossover switch between the first circuit board and the second circuit board. Responsive to the operational status of one of the first power supply or the second power supply being in a non-operational state, the electronic brake booster module may be configured to determine the fault state to be a single power supply fault, and responsive to the determining the fault state to be the single power supply fault, the electronic brake booster module may be configured to execute the fallback condition to have the crossover switch transfer power to one or more of the first circuit board or the second circuit board experiencing the single power supply fault from a remaining one or more of the first circuit board or the second circuit board not experiencing the single power supply fault. In some cases, the first circuit board may have a first microcontroller and the second circuit board has a second microcontroller. The first circuit board and the second circuit board may communicate with one another via a private communication link between the first microcontroller and the second microcontroller, and the private communication link may determine crossover switch function. In an example embodiment, the braking system may further include rear brakes. The front brakes may be hydraulic brakes, and the rear brakes may be electro-mechanical brakes with separate power supplies from the first power supply and the second power supply. In an example embodiment, wherein responsive to the operational status of both the first power supply and the second power supply being in a non-operational state, the vehicle control module may determine the fault state to be a double power supply fault, and responsive to determining the fault state to be the double power supply fault, the vehicle control module may be configured to execute the fallback condition to have the front brakes operate according to a hydraulic fallback and the rear brakes operate according to an electro-mechanical assist fallback. In an example embodiment, the hydraulic fallback may provide hydraulic fluid into calipers of the front brakes based on the pedal actuation, and the electro-mechanical assist fallback may provide varying degree of electro-mechanical braking based proportionally on the brake pedal angle. In some cases, the first power supply and the second power supply may be operably coupled to other components of the vehicle other than the electronic brake booster module, and the other components may further include additional sensors, modules, and devices outside of the vehicle control system. In an example embodiment, the first circuit board may control brake actuation via determining if brake boosting is needed, and the second circuit board may control brake modulation via determining a degree of brake boosting to achieve a target torque. In some cases, the vehicle may be an autonomous vehicle, and the electronic brake booster module may be a single box further including an electrical control unit and a hydraulic control unit. The electronic brake booster module, the first power supply, and the second power supply may provide the vehicle with L3+ autonomous driving capability.

In another example embodiment, an electronic brake booster module for a vehicle control system of a vehicle may therefore be provided. The electronic brake booster module may include a first circuit board to control brake actuation, and a second circuit board to control brake modulation. A first power supply and a second power supply may be operably coupled to the electronic brake booster module, and the electronic brake booster module may be configured to adjust front brakes of a braking system of the vehicle. The electronic brake booster may be further operably coupled to a pedal travel sensor operably coupled to a brake pedal of the vehicle to measure pedal actuation and a pedal angle sensor operably coupled to the pedal of the vehicle to measure pedal angle. The electronic brake booster module or a vehicle control module of the vehicle control system may determine a fallback condition based on a fault state determined based on the pedal actuation, the brake pedal angle, and operational status of one or more of the first power supply and the second power supply.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A vehicle control system of a vehicle comprising:
an electronic brake booster module to adjust front brakes of a braking system of the vehicle;
a pedal travel sensor operably coupled to a brake pedal of the vehicle to measure pedal actuation;
a pedal angle sensor operably coupled to the brake pedal of the vehicle to measure pedal angle;
a vehicle control module configured to monitor the vehicle control system;
a first power supply operably coupled to the electronic brake booster module; and
a second power supply operably coupled to the electronic brake booster module,
wherein the electronic brake booster module further comprises a first circuit board to control brake actuation and a second circuit board to control brake modulation, and
wherein the vehicle control module or the electronic brake booster module determines a fallback condition based on a fault state determined based on the pedal actuation, the pedal angle, and operational status of one or more of the first power supply and the second power supply.

2. The vehicle control system of claim 1, wherein the first power supply is operably coupled to the first circuit board, and
wherein the second power supply is operably coupled to the second circuit board.

3. The vehicle control system of claim 1, wherein the electronic brake booster module further comprises a crossover switch between the first circuit board and the second circuit board,
wherein responsive to the operational status of one of the first power supply or the second power supply being in a non-operational state, the electronic brake booster module is configured to determine the fault state to be a single power supply fault, and
wherein responsive to the determining the fault state to be the single power supply fault, the electronic brake booster module is configured to execute the fallback condition to have the crossover switch transfer power to one or more of the first circuit board or the second circuit board experiencing the single power supply fault from a remaining one or more of the first circuit board or the second circuit board not experiencing the single power supply fault.

4. The vehicle control system of claim 3, wherein the first circuit board has a first microcontroller and the second circuit board has a second microcontroller,
wherein the first circuit board and the second circuit board communicate with one another via a private communication link between the first microcontroller and the second microcontroller, and
wherein the private communication link determines crossover switch function.

5. The vehicle control system of claim 1, wherein the braking system further comprises rear brakes,
wherein the front brakes are hydraulic brakes, and
wherein the rear brakes are electro-mechanical brakes with separate power supplies from the first power supply and the second power supply.

6. The vehicle control system of claim 5, wherein responsive to the operational status of both the first power supply and the second power supply being in a non-operational state, the vehicle control module determines the fault state to be a double power supply fault, and
wherein responsive to determining the fault state to be the double power supply fault, the vehicle control module is configured to execute the fallback condition to have the front brakes operate according to a hydraulic fallback and the rear brakes operate according to an electro-mechanical assist fallback.

7. The vehicle control system of claim 6, wherein the hydraulic fallback provides hydraulic fluid into calipers of the front brakes based on the pedal actuation, and
wherein the electro-mechanical assist fallback provides varying degrees of electro-mechanical braking based proportionally on the brake pedal angle.

8. The vehicle control system of claim 1, wherein the first power supply and the second power supply are operably coupled to other components of the vehicle other than the electronic brake booster module,
wherein the other components further comprise additional sensors, modules, and devices outside of the vehicle control system.

9. The vehicle control system of claim 1, wherein the first circuit board controls brake actuation via determining if brake boosting is needed, and
wherein the second circuit board controls brake modulation via determining a degree of brake boosting to achieve a target torque.

10. The vehicle control system of claim 1, wherein the vehicle is an autonomous vehicle,
wherein the electronic brake booster module is a single box further comprising an electrical control unit and a hydraulic control unit, and
wherein the electronic brake booster module, the first power supply, and the second power supply provide the vehicle with L3+ autonomous driving capability.

11. An electronic brake booster module for a vehicle control system of a vehicle, the electronic brake booster module comprising:
a first circuit board to control brake actuation; and
a second circuit board to control brake modulation,
wherein a first power supply and a second power supply are operably coupled to the electronic brake booster module,
wherein the electronic brake booster module is configured to adjust front brakes of a braking system of the vehicle,
wherein the electronic brake booster is further operably coupled to a pedal travel sensor operably coupled to a brake pedal of the vehicle to measure pedal actuation and a pedal angle sensor operably coupled to the pedal of the vehicle to measure pedal angle, and
wherein the electronic brake booster module or a vehicle control module of the vehicle control system determines a fallback condition based on a fault state determined based on the pedal actuation, the brake pedal angle, and operational status of one or more of the first power supply and the second power supply.

12. The electronic brake booster module of claim 11, wherein the first power supply is operably coupled to the first circuit board, and
wherein the second power supply is operably coupled to the second circuit board.

13. The electronic brake booster module of claim 11, wherein the electronic brake booster module further comprises a crossover switch between the first circuit board and the second circuit board,
wherein responsive to the operational status of one of the first power supply or the second power supply being in a non-operational state, the electronic brake booster module is configured to determine the fault state to be a single power supply fault, and
wherein responsive to the determining the fault state to be the single power supply fault, the electronic brake booster module is configured to execute the fallback condition to have the crossover switch transfer power to one or more of the first circuit board or the second circuit board experiencing the single power supply fault from a remaining one or more of the first circuit board or the second circuit board not experiencing the single power supply fault.

14. The electronic brake booster module of claim 13, wherein the first circuit board has a first microcontroller and the second circuit board has a second microcontroller,
wherein the first circuit board and the second circuit board communicate with one another via a private communication link between the first microcontroller and the second microcontroller, and
wherein the private communication link determines crossover switch function.

15. The electronic brake booster module of claim 11, wherein the braking system further comprises rear brakes,
wherein the front brakes are hydraulic brakes, and
wherein the rear brakes are electro-mechanical brakes with separate power supplies from the first power supply and the second power supply.

16. The electronic brake booster module of claim 15, wherein responsive to the operational status of both the first power supply and the second power supply being in a non-operational state, the vehicle control module determines the fault state to be a double power supply fault, and
wherein responsive to determining the fault state to be the double power supply fault, the vehicle control module is configured to execute the fallback condition to have the front brakes operate according to a hydraulic fallback and the rear brakes operate according to an electro-mechanical assist fallback.

17. The electronic brake booster module of claim 16, wherein the hydraulic fallback provides hydraulic fluid into calipers of the front brakes based on the pedal actuation, and
wherein the electro-mechanical assist fallback provides varying degrees of electro-mechanical braking based proportionally on the brake pedal angle.

18. The electronic brake booster module of claim 11, wherein the first power supply and the second power supply are operably coupled to other components of the vehicle other than the electronic brake booster module,
wherein the other components further comprise additional sensors, modules, and devices outside of the vehicle control system.

19. The electronic brake booster module of claim 11, wherein the first circuit board controls brake actuation via determining if brake boosting is needed, and
wherein the second circuit board controls brake modulation via determining a degree of brake boosting to achieve a target torque.

20. The electronic brake booster module of claim 11, wherein the vehicle is an autonomous vehicle,
wherein the electronic brake booster module is a single box further comprising an electrical control unit and a hydraulic control unit, and
wherein the electronic brake booster module, the first power supply, and the second power supply provide the vehicle with L3+ autonomous driving capability.
